(19) United States
(12) Patent Application Publication
(10) Pub. No.: US 2026/0354366 A1
(43) Pub. Date: Nov. 12, 2026

(54) INSECT BAIT APPARATUSES AND METHODS THEREOF

(71) Applicant: United Industries Corporation, Earth City, MO (US)

(72) Inventors: Kristina THOMPSON, Earth City, MO (US); Josh MATTA, Earth City, MO (US); Amie BEST, Earth City, MO (US); Mark KURTH, Earth City, MO (US); Tammy BALZAR, Earth City, MO (US); Alex J. WALL, Earth City, MO (US)

(21) Appl. No.: 19/486,497

(22) PCT Filed: Jun. 5, 2024
(86) PCT No.: PCT/US2024/032562

§ 371 Date: Nov. 21, 2025

Related U.S. Application Data
(60) Provisional application No. 63/506,941, filed on Jun. 8, 2023.

(51) Int. Cl. A01M 1/20; A01M 1/02

(52) U.S. Cl. CPC A01M 1/2011; A01M 1/02

(57) ABSTRACT

An insect bait apparatus is configured to hold insect bait. The apparatus has a housing body includes a first end and an opposite second end defining a longitudinal axis. A first wall and a second wall extends from an edge, and a third wall extends between the first wall and the second wall. The first wall, the second wall, and the third wall defines an interior chamber of the housing body. A bait chamber extends between the first wall and the second wall within the interior chamber and is configured to receive the bait. A first opening is defined at the first end allowing access to the interior chamber. A second opening is defined at the second end allowing access to the interior chamber.

### CROSS-REFERENCE TO RELATED APPLICATION

This application claims benefit of U.S. Provisional Patent Application No. 63/506,941 filed Jun. 8, 2023 and titled “INSECT BAIT APPARATUSES AND METHOD THEREOF” the disclosure of which is hereby incorporated herein by reference in its entirety.

### BACKGROUND

This disclosure relates generally to insect bait apparatuses and, more particularly, to an insect bait housing configured to hold insect bait such that the insect bait housing is selectively positionable in at least two orientations in order to address insect problems at the source.

Insect bait is typically a mixture of an active ingredient, such as an insecticide, mixed with a food item that attracts insects. The bait is placed at locations that the insect comes into contact with so the insect carries the bait back to a nest and other insects can collect additional bait. Proper placement of the bait is desired so that the bait is placed in areas of insect activity, but also out of reach for children, pets, wildlife and the like. Accordingly, insect bait apparatuses that hold the bait while also being able to be operable in a wide variety of orientations are desired so that placement efficiencies are increased.

### SUMMARY

The present disclosure relates generally to insect bait apparatuses that are positionable in two or more different orientations. A housing body is elongated along a longitudinal axis and includes openings at both ends for allowing access into an interior chamber defined therein. The interior chamber is configured to hold insect bait. The housing body includes three walls with a bait chamber therein configured to support the bait and two of the walls are configured for use in placement of the insect bait apparatus in an infestation area. By having the bait be supported relative to the housing body openings no matter what the placement orientation of the housing body, the insect bait apparatus increases its efficacy in a wide variety of infestation areas.

In an aspect, the technology relates to an insect bait apparatus configured to hold bait having at least one active ingredient, the apparatus including: a housing body defining an interior chamber, the housing body including: a first end and an opposite second end defining a longitudinal axis; a first wall and a second wall extending from an edge, wherein the first wall has a first exterior surface and the second wall having a second exterior surface, the first exterior surface at a 90° angle relative to the second exterior surface; a third wall extending between the first wall and the second wall, the third wall having an inner surface at least partially defining the interior chamber, wherein at least a portion of the inner surface has a 45° angle relative to the first wall and the second wall, and wherein the inner surface is configured to at least partially support the bait; a first opening defined at the first end allowing access to the interior chamber; and a second opening defined at the second end allowing access to the interior chamber; a first end cap removably coupled to the first end and covering the first opening; and a second end cap removably coupled to the second end and covering the second opening.

In an example, the housing body has a cross-sectional profile that is larger at a mid-plane than at the first end or the second end. In another example, the housing body is symmetrical about the mid-plane. In yet another example, the edge is a first edge, the housing body also including a second edge at an intersection of the first wall and the third wall, the first edge is linear between the first and second ends and the second edge is curved between the first and second ends. In still another example, the first exterior surface has a surface area that is equal to the second exterior surface. In an example, the third wall has a third exterior surface, the third exterior surface having a surface area that is greater than the first exterior surface.

In another example, the first opening is axially aligned with the second opening along the longitudinal axis. In yet another example, the inner surface is a third inner surface, and the first wall includes a first inner surface and the second wall includes a second inner surface, and the first opening and the second opening are defined by the third wall, the first inner surface, and the second inner surface. In still another example, each of the first and second end caps includes a projection configured to be received at least partially within the housing body and a flanged cover configured to at least partially cover the third wall. In an example, the housing body is rigid. In another example, each of the first wall, the second wall, and the third wall have equal thicknesses.

In yet another example, the interior chamber is free from any moving components. In still another example, an adhesive is disposed at least partially on the first exterior surface, the second exterior surface, or both the first and second exterior surfaces.

In another aspect, the technology relates to an insect bait apparatus including: a housing body including at least a first wall having a first inner surface and a first outer surface, a second wall having a second inner surface and a second outer surface, and a third wall having a third inner surface and a third outer surface, wherein the first inner surface, the second inner surface, and the third inner surface at least partially define an interior chamber, wherein the first inner surface is orthogonal relative to the second inner surface, and wherein the housing body extends between a first end and a second end defining a longitudinal axis, the first end defining a first opening into the interior chamber and the second end defining a second opening into the interior chamber; a first end cap removably coupled to the first end and covering the first opening; a second end cap removably coupled to the second end and covering the second opening; an adhesive disposed at least partially on the first outer surface, the second outer surface, or both the first and second outer surfaces; and bait having at least one active ingredient disposed within the interior chamber, wherein the bait is at least partially supported by the third inner surface and is oriented at a 45° angle relative to the first inner surface and the second inner surface.

In an example, the third outer surface is non-planar and the first outer surface and the second outer surface are planar. In another example, the third inner surface is disposed at a 45° angle relative to the first inner surface and the second inner surface. In yet another example, the interior chamber has a triangular cross-sectional shape. In still another example, the cross-sectional shape is at its largest at a mid-plane of the housing body. In an example, the first wall and the second wall intersect at an edge, the housing body symmetrical relative to the edge.

In another example, when the first end cap and the second end cap are coupled to the housing body, at least a portion of the first and second end caps project outwards from the third outer surface. In yet another example, the first interior surface has a surface area that is equal to the second interior surface. In still another example, the third interior surface has a surface area that is greater than the first interior surface.

In another aspect, the technology relates to a method of assembling an insect bait apparatus including: providing a housing body including at least a first wall having a first inner surface and a first outer surface, a second wall having a second inner surface and a second outer surface, and a third wall having a third inner surface and a third outer surface, wherein the first inner surface, the second inner surface, and the third inner surface at least partially define an interior chamber, wherein the first inner surface is orthogonal relative to the second inner surface, and wherein the housing body extends between a first end and a second end defining a longitudinal axis, the first end defining a first opening into the interior chamber and the second end defining a second opening into the interior chamber; inserting bait having at least one active ingredient within the interior chamber, wherein the bait is at least partially supported by the third inner surface and is oriented at a 45° angle relative to the first inner surface and the second inner surface; removably coupling a first end cap to the first end and covering the first opening; removably coupling a second end cap to the second end and covering the second opening; and attaching an adhesive at least partially on the first outer surface, the second outer surface, or both the first and second outer surfaces.

In another aspect, the technology relates to an insect bait apparatus configured to hold bait having at least one active ingredient, the apparatus including: a housing body including: a first end and an opposite second end defining a longitudinal axis; a first wall and a second wall extending from an edge, wherein the first wall has a first exterior surface and the second wall has a second exterior surface, the first exterior surface at a 90° angle relative to the second exterior surface; a third wall extending between the first wall and the second wall, the first wall, the second wall, and the third wall defining an interior chamber of the housing body; a bait chamber extending between the first wall and the second wall within the interior chamber, the bait chamber configured to at least partially receive the bait; a first opening defined at the first end allowing access to the interior chamber; and a second opening defined at the second end allowing access to the interior chamber.

In an example, the housing body has a cross-sectional profile that is larger at a mid-plane than at the first end or the second end. In another example, the housing body is symmetrical about the mid-plane. In yet another example, the edge is a first edge, the housing body also including a second edge at an intersection of the first wall and the third wall, the first edge is linear between the first and second ends and the second edge is curved between the first and second ends. In still another example, the first exterior surface has a surface area that is equal to the second exterior surface. In an example, the third wall has a third exterior surface, the third exterior surface having a surface area that is greater than the first exterior surface.

In another example, the first opening is axially aligned with the second opening along the longitudinal axis. In yet another example, the first opening and the second opening are completely defined by the first wall, the second wall, and the third wall. In still another example, the bait chamber includes a first ramp adjacent the first opening and a second ramp adjacent the second opening. In an example, the housing body is rigid. In another example, the first wall and the second wall are integrally formed as a base and the third wall is a cover, the cover ultrasonically welded to the base to form the housing body.

In yet another example, the interior chamber is free from any moving components. In still another example, an adhesive is disposed at least partially on the first exterior surface, the second exterior surface, or both the first and second exterior surfaces. In an example, the bait chamber includes at least one shoulder, and a pull-tab seal engages with the at least one shoulder to seal the bait therein.

In another aspect, the technology relates to an insect bait apparatus including: a housing body including: a base having a first wall and a second wall, wherein the first wall and the second wall extend orthogonally from each other from an edge, a bait chamber extends between the first wall and the second wall and has a centerline axis that bisects the edge; and a cover forming a third wall, wherein the base and the cover at least partially define an interior chamber with the bait chamber captured therein, wherein the housing body extends between a first end and a second end defining a longitudinal axis, the first end defining a first opening into the interior chamber and the second end defining a second opening into the interior chamber; and bait having at least one active ingredient disposed within the bait chamber.

In an example, the third wall is non-planar and the first wall and the second wall are substantially planar. In another example, the bait chamber is elongated along the longitudinal axis with a first ramp proximate the first opening and a second ramp proximate the second opening. In yet another example, the bait chamber has a trapezoidal cross-sectional shape. In still another example, distal ends of the first and the second wall define a channel and the third wall includes one or more tabs, the one or more tabs receivable within the channel to couple the cover to the base. In an example, the cover is ultrasonically welded to the base.

In another example, a seal is included for the bait chamber. In yet another example, the seal has a pull-tab extending from the first opening or the second opening. In still another example, the housing body is symmetrically about the edge. In an example, an adhesive is configured to be applied at least partially on an outer surface of the housing body.

In another aspect, the technology relates to a method of assembling an insect bait apparatus including: providing a housing body including a base having a first wall and a second wall, the first wall and the second wall extend orthogonally from each other from an edge, a bait chamber extends between the first wall and the second wall and has a centerline axis that bisects the edge, and a cover forming a third wall, the base and the cover at least partially define an interior chamber with the bait chamber captured therein, the housing body extends between a first end and a second end defining a longitudinal axis, the first end defining a first opening into the interior chamber and the second end defining a second opening into the interior chamber; inserting bait having at least one active ingredient within the bait chamber; and coupling the cover to the base forming the housing body with the bait disposed therein.

In an example, the method further includes providing an adhesive configured to be applied at least partially on an outer surface of the housing body. In another example, the method further includes sealing the housing body in packaging. In yet another example, the method further includes sealing the bait chamber with a pull-tab seal.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular examples of the present disclosure and therefore do not limit the scope of the present disclosure. The drawings are not to scale and are intended for use in conjunction with the explanations in the following detailed description. Examples of the present disclosure will hereinafter be described in conjunction with the appended drawings, wherein like numerals denote like elements.

FIG. 1 is a perspective view of an insect bait apparatus and in accordance with the principles of the present disclosure.

FIG. 2 is another perspective view of the insect bait apparatus shown in FIG. 1.

FIG. 3 is an exploded, perspective view of the insect bait apparatus shown in FIG. 1.

FIG. 4 is a plan view of first and second walls of a housing body of the insect bait apparatus shown in FIG. 1.

FIG. 5 is a plan view of a third wall of the housing body the insect bait apparatus shown in FIG. 1.

FIG. 6 is a cross-sectional, perspective view of the insect bait apparatus shown in FIG. 1.

FIG. 7 is an end elevation view of the housing body of the insect bait apparatus shown in FIG. 1.

FIG. 8 is a cross-sectional view of the insect bait apparatus shown in FIG. 1 and taken along line 8-8 as shown in FIGS. 4 and 5.

FIG. 9 is a perspective view of an end cap of the insect bait apparatus shown in FIG. 1.

FIG. 10 is a perspective view of the end cap of the insect bait apparatus shown in FIG. 1.

FIG. 11 is a perspective view of another insect bait apparatus and in accordance with the principles of the present disclosure.

FIG. 12 is another perspective view of the insect bait apparatus shown in FIG. 11.

FIG. 13 is an exploded, perspective view of the insect bait apparatus shown in FIG. 11. FIG. 14 is another exploded, perspective view of the insect bait apparatus shown in FIG. 11.

FIG. 15 is a side view of a first wall of the insect bait apparatus shown in FIG. 11.

FIG. 16 is an end view of the insect bait apparatus shown in FIG. 11.

FIG. 17 is a plan view of a base of the insect bait apparatus shown in FIG. 11.

FIG. 18 is a cross-sectional view of the insect bait apparatus shown in FIG. 11 and taken along line 18-18 as shown in FIG. 15.

FIG. 19 is a schematic view of a seal for the insect bait apparatus shown in FIG. 11.

FIG. 20 is another schematic view of the seal for the insect bait apparatus shown in FIG. 11.

FIG. 21 is a perspective view of another insect bait apparatus and in accordance with the principles of the present disclosure.

FIG. 22 is another perspective view of the insect bait apparatus shown in FIG. 21.

FIG. 23 is a perspective view of another insect bait apparatus and in accordance with the principles of the present disclosure.

FIG. 24 is a perspective view of another insect bait apparatus and in accordance with the principles of the present disclosure.

FIG. 25 is an exploded, perspective view of the insect bait apparatus shown in FIG. 24.

FIG. 26 illustrates a flowchart depicting a method of assembling an insect bait apparatus and in accordance with the principles of the present disclosure.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible embodiments for the appended claims.

Throughout this description, references to orientation (e.g., front(ward), rear(ward), top, bottom, back, right, left, upper, lower, etc.) of the components of the insect bait apparatus are used for ease of description and illustration only. No restriction is intended by use of the terms regardless of how the components of the insect bait apparatus are situated on its own.

In the examples described herein, an insect bait apparatus includes an elongated housing body having openings at each end. The housing body defines an interior chamber that is configured to hold insect bait. The structure of the housing body allows the housing body to be positioned on an attachment surface in at least two different orientations so as to increase ease of use of the insect bait apparatus. The bait is supported at least partially within a bait chamber of the housing body with at least two walls configured for engaging the attachment surface. As such, the bait is oriented relative to the openings the same in two or more orientations of the housing body.

The insect bait apparatus may include end caps that seal the bait within the housing body until the apparatus is ready for use. In other aspect, the bait is sealed via packaging or with a pull-tab seal over the bait chamber. The housing body can also include an adhesive for securing the insect bait apparatus to the attachment surface. The insect bait apparatus can be used outdoors or indoors as required or desired.

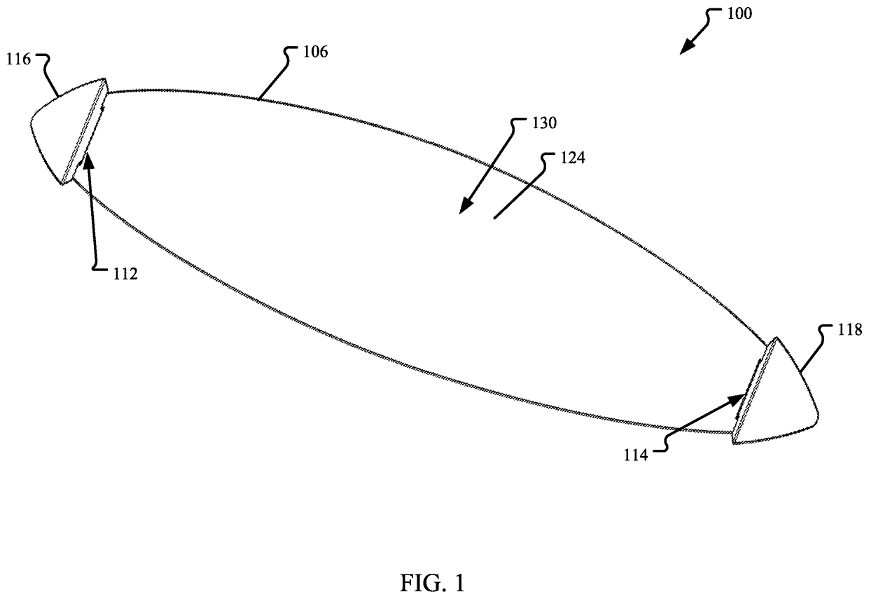

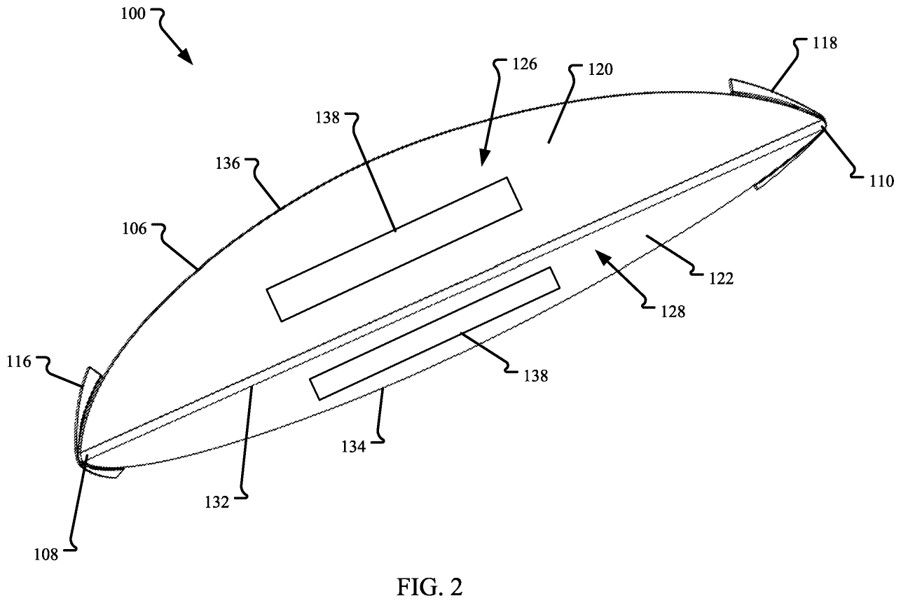

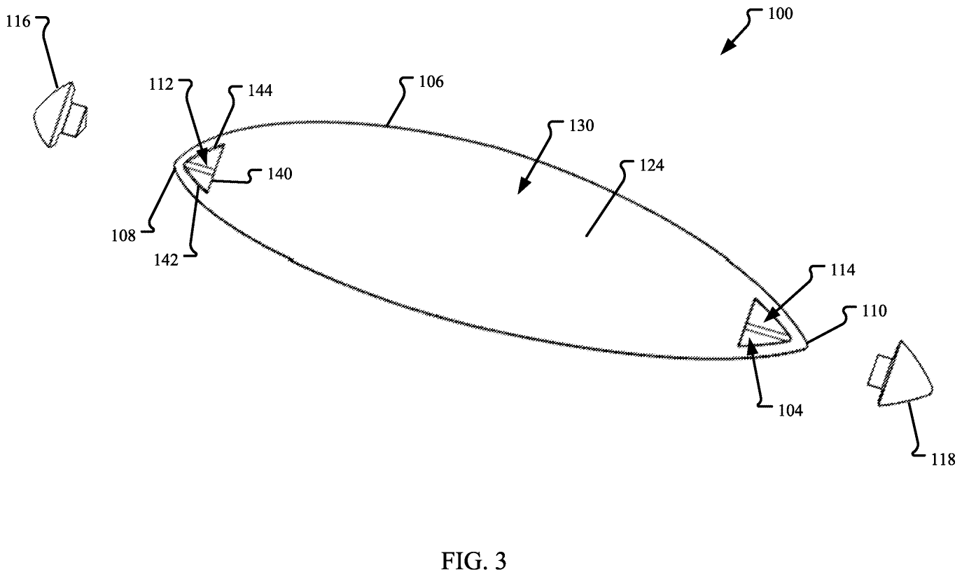

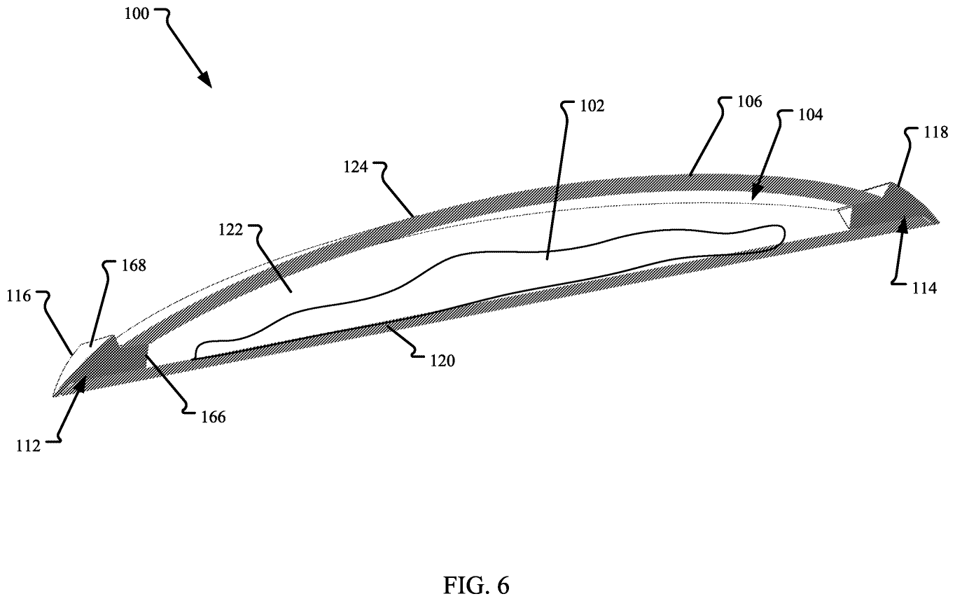

FIG. 1 is a perspective view of an insect bait apparatus 100. FIG. 2 is another perspective view of the insect bait apparatus 100. FIG. 3 is an exploded, perspective view of the insect bait apparatus 100. Referring concurrently to FIGS. 1-3, the insect bait apparatus 100 is configured to hold a charge of bait 102 (shown in FIG. 6). The bait 102 can include at least one active ingredient, such as an insecticide, and at least one food component configured to attract insects. In operation the bait 102 attracts insects, allows the insects to carry the bait back to the nest, and allow other insects to collect the bait 102. The active ingredient may not be immediately acting on the insects, but rather, allows for the bait to be spread throughout the nest. In examples, the bait may be configured for insects such as ants or cockroaches. It is appreciated that other insects are also contemplated herein.

The bait 102 is held withing an interior chamber 104 defined by a housing body 106 for storage, transportation, and use. In the example, the housing body 106 includes a first end 108 and an opposite second end 110. The first end 108 defines a first opening 112 that allows access into the interior chamber 104. The second end 110 defines a second opening 114 that allows access into the interior chamber 104. The insect bait apparatus 100 also includes a first end cap 116 that is removably coupled to the first end 108 of the housing body 106 and that covers and/or seals the first opening 112. A second end cap 118 is removably coupled to the second end 110 of the housing body 106 and that covers and/or seals the second opening 114.

The housing body 106 includes a first wall 120 extending between the first end 108 and the second end 110. A second wall 122 extends between the first end 108 and the second end 110. Additionally, a third wall 124 extends between the first end 108 and the second end 110. The first wall 120 has a first exterior (e.g. outer) surface 126 that extends between the second and third walls 122, 124, the second wall 122 has a second exterior surface 128 that extends between the first and third walls 120, 124, and the third wall 124 has a third exterior surface 130 that extends between the first and second walls 120, 122. The first exterior surface 126, second exterior surface 128, and third exterior surface 130 form the exterior or outer surface of the housing body 106.

The first wall 120 and the second wall 122 intersect at a first edge 132. The second wall 122 and the third wall 124 intersect at a second edge 134. The third wall 124 and the first wall 120 intersect at a third edge 136.

In the example, an adhesive 138 may be disposed at least partially on the first exterior surface 126, the second exterior surface 128, or both the first and second exterior surfaces 126, 128. The adhesive 138 is configured to secure the housing body 106 to an attachment surface during use. In examples, the adhesive 138 may be double sided tape, a film, or the like with a removable tear-away liner. The adhesive 138 may be pre-applied to the housing body 106, or the adhesive 138 may be supplied with the housing body 106 and the end user applies the adhesive 138 to the housing body 106 in a required or desired area. In aspects, the housing body 106 may not include the adhesive if required or desired.

In operation, the bait 102 is sealed within the interior chamber 104 of the housing body 106 via the first and second end caps 116, 118 at least partially within the first and second openings 112, 114. This configuration enables the insect bait apparatus 100 to be shipped and stored until use is required or desired. In use, the first and second end caps 116, 118 are removed and the housing body 106 is placed on an attachment surface and within an area that contains insects. The first and/or second exterior surfaces 126, 128 are placed on the attachment surface and the adhesive 138 can be used to removably secure the housing body 106 to the attachment surface. The geometry of the housing body 106 enables the housing body 106 to have different orientations while on the attachment surface while still facilitating insect access to the bait 102 within.

For example, the housing body 106 can be placed along a wall with the first exterior surface 126 on the floor and the second exterior surface 128 on the wall, or with the second exterior surface 128 on the floor and the first exterior surface 126 on the wall. Both orientations allow for insects to access the bait within the housing body 106. In other examples, the housing body 106 can be placed in cracks or crevices on an underlying surface (e.g., the first edge 132 being inserted at least partially within the crack or crevice). In still other examples, the housing body 106 can be placed on surface of trash receptacles, cabinets, and the like. In aspect, the adhesive 138 allows for the housing body 106 to be secured underneath a surface and without falling down. The interior chamber 104 of the housing body 106 can be free from any moving components such that orientation of the housing body 106 does not matter. In examples, the housing body 106 is a plastic-based component that is substantially rigid. In an aspect, the housing body 106 is not an extruded component.

In the example, the first exterior surface 126 is at a 90° angle relative to the second exterior surface 128. This configuration enables the first wall 120, the second wall 122, or both the first and second walls 120, 122 to be disposed directly against a surface when in use. In an aspect, the first exterior surface 126 has a surface area that is equal to the second exterior surface 128. The third exterior surface 130 has a surface area that is greater than the first exterior surface 126. The third exterior surface 130 also has a surface area that is greater than the second exterior surface 128. In examples, the third exterior surface 130 has a surface area that is 10% greater than the first or second exterior surfaces 126, 128. The third exterior surface 130 has a surface area that is 20% greater than the first or second exterior surfaces 126, 128. The third exterior surface 130 has a surface area that is 30% greater than the first or second exterior surfaces 126, 128. The third exterior surface 130 has a surface area that is 40% greater than the first or second exterior surfaces 126, 128. The third exterior surface 130 has a surface area that is 50% greater than the first or second exterior surfaces 126, 128.

The bait 102 of the insect bait apparatus 100 is disposed within the interior chamber 104 and at the intersection of the first wall 120 and the second wall 122. This placement of the bait 102 enables the housing body 106 to be used in at least two different orientations. In other examples, the bait 102 of the insect bait apparatus 100 may be disposed on an inner surface of the third wall 124 so that the housing body 106 can be used in at least two different orientations and increasing the size of the third wall 124 can increase an amount of bait that can be held within the housing body 106.

Turning specifically to FIG. 3, the first and second openings 112, 114 are defined on the third wall 124 so that the housing body 106 can be used in at least two different orientations. In the example, the first and second openings 112, 114 have the same size and shape (e.g., triangular). In other examples, the first and second openings 112, 114 may be different in size and/or shape as required or desired. The first and second opening 112, 114 have a transverse edge 140 and a pair of oblique edges 142, 144. The transverse edge 140 may be formed entirely by the third wall 124. The oblique edges 142, 144 may be formed by inner surfaces of the first and second walls 120, 122, respectively.

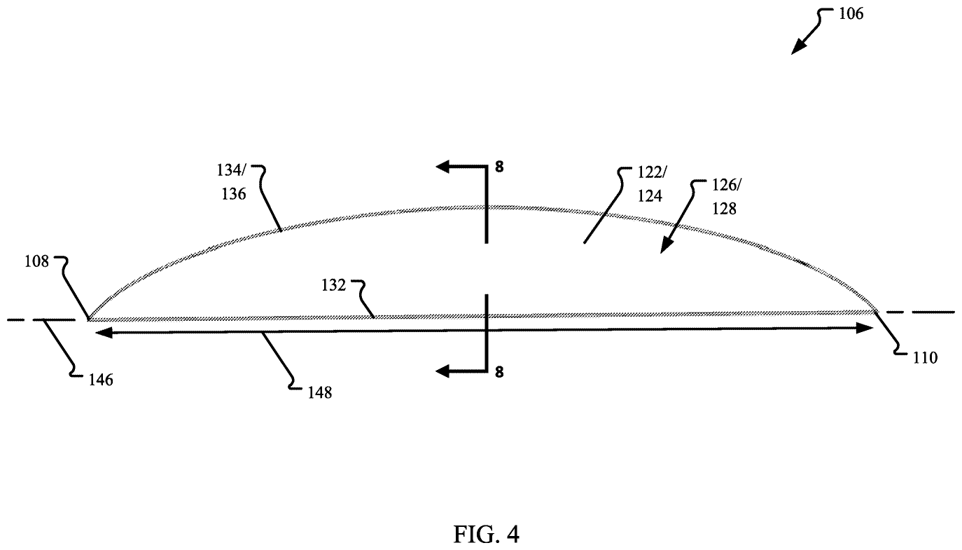

FIG. 4 is a plan view of the first and second walls 120, 122 of the insect bait apparatus 100 (shown in FIGS. 1-3). Because the first and second walls 120, 122 of the housing body 106 are similar, the plan views of each are the same. The end caps 116, 118 (shown in FIG. 3) are not illustrated for clarity. The first end 108 and the second end 110 of the housing body 106 define a longitudinal axis 146. The first edge 132 extends parallel and is linear with respect to the longitudinal axis 146 between the first and second ends 108, 110. Additionally, the first and second walls 120, 122 also extend parallel and are linear with respect to the longitudinal axis 146. The first and second exterior surface 126, 128 are also parallel and planer with respect to the longitudinal axis 146. In contrast, the second and third edges 134, 136 are curved and non-parallel with respect to the longitudinal axis 146 between the first and second ends 108, 110.

The first edge 132 defines a longitudinal length 148 of the housing body 106. In an aspect, a length of the second and third edges 134, 136, because they are curved, are longer than the longitudinal length 148 of the first edge 132.

Line 8-8 is illustrated at the longitudinal mid-point of the housing body 106 in FIG. 4 and defines a mid-plane (e.g., a plane that extends in and out of the page). The housing body 106 is symmetrical about the mid-plane so that the insect bait apparatus 100 can be used in at least two different orientations. The housing body 106 has a cross-sectional profile at the mid-plane that is larger than at the first or second ends 108, 110.

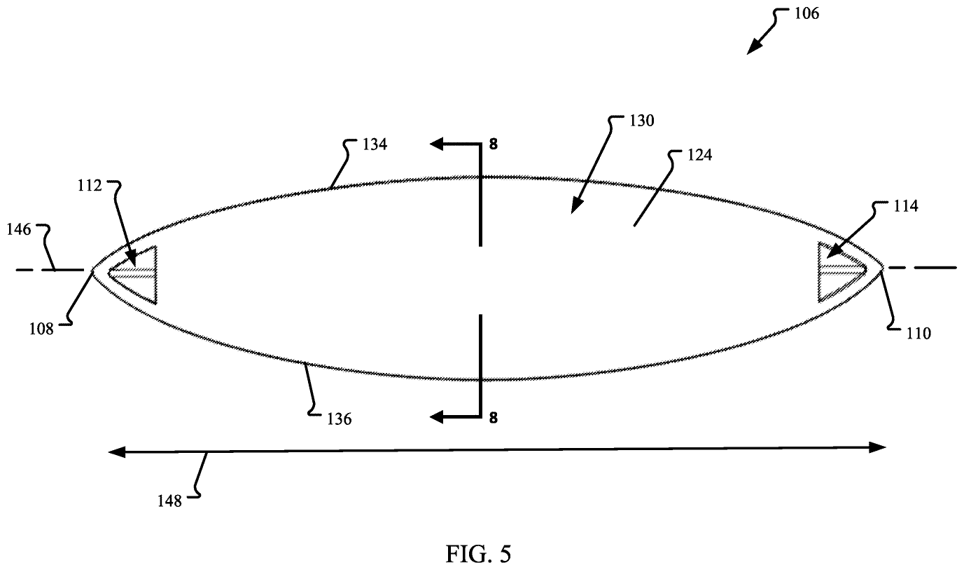

FIG. 5 is a plan view of the third wall 124 of the insect bait apparatus 100 (shown in FIGS. 1-3). The end caps 116, 118 (shown in FIG. 3) are not illustrated for clarity. The third wall 124 extends along the longitudinal axis 146, however, the third wall is non-parallel and non-planar with respect to the longitudinal axis 146. The second and third edges 134, 136 are curved relative to the longitudinal axis 146. The first and second openings 112, 114 are axially aligned along the longitudinal axis 146. Further, the housing body 106 has a cross-sectional profile at the mid-plane that is larger than at the first or second ends 108, 110.

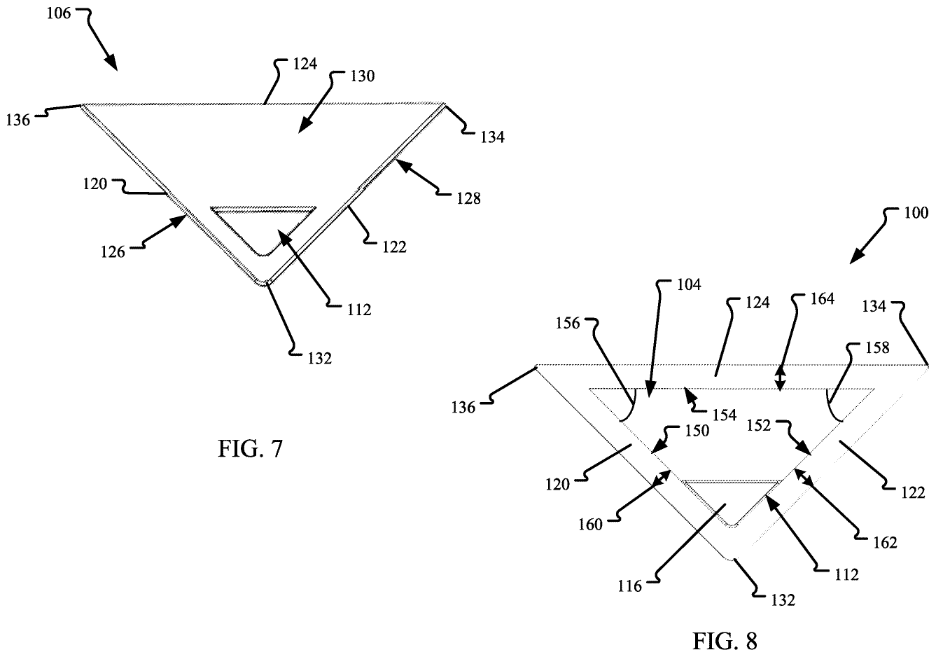

The first and second openings 112, 114 have an opening plane that is non-parallel and non-orthogonal relative to the longitudinal axis 146. As such, the first and second openings 112, 114 are disposed at an angle relative to the longitudinal axis 146. FIG. 7 is an end elevation view of the housing body 106 of the insect bait apparatus 100 (shown in FIGS. 1-3). The third exterior surface 130 of the third wall 124 is visible as it curves upwards to the mid-plane as described above. The first and second walls 120, 122, and thus, the first and second exterior surfaces 126, 128 are orthogonal to each other thereby forming a triangular end profile shape. The first opening 112 allows for insect access into the interior chamber 104 defined by the housing body 106. In the example, the first opening 112 has a similar triangular profile, but smaller in size, to that of a perimeter of the outer surface of the housing body 106. The housing body 106 is symmetrical about the first edge 132 so that the insect bait apparatus 100 can be used in at least two different orientations. The end elevation view of the housing body 106 from the second end is similar.

The third exterior surface 130 extends completely around the first opening 112 such that insect access into the housing body 106 is similar with the first wall 120 laid flat on the attachment surface or the second wall 122 laid flat on the attachment surface. In the example, the first edge 132 is rounded between the first wall 120 and the second wall 122.

Further views of the insect bait apparatus 100 are shown in U.S. Design patent application Ser. No. 29/759,169, filed Nov. 20, 2020, tilted “INSECT BAIT DEVICE”, and which is incorporated by reference herein in its entirety.

Referring back to FIG. 6, it is a cross-sectional, perspective view of the insect bait apparatus 100. The cross-section plane is taken along the longitudinal axis 146 (shown in FIGS. 4 and 5) and parallel to the second wall 122. FIG. 8 is a cross-sectional view of the insect bait apparatus 100 and taken along line 8-8 as shown in FIGS. 4 and 5. Referring concurrently to FIGS. 6 and 8, the first wall 120 has a first inner surface 150, the second wall 122 has a second inner surface 152, and the third wall 124 has a third inner surface 154. The first inner surface 150, second inner surface 152, and third inner surface 154 defines the interior chamber 104 of the housing body 106 that is configured to hold the bait 102.

In the example, the interior intersection of the first wall 120 and the second wall 122 is configured to at least partially support the bait 102. As such, the bait 102 is disposed against the first inner surface 150 and the second inner surface 152. By supporting the bait 102 on both the first wall 120 and the second wall 122, the insects are able to access the bait 102 when the housing body 106 is in different orientations. Additionally, injecting the bait 102 into the interior chamber 104 from the ends is facilitated. In other examples, the third inner surface 154 of the third wall 124 may be configured to at least partially support the bait 102. By supporting the bait 102 on the third wall 124, the insects are also able to access the bait 102 when the housing body 106 is in different orientations. For example, if the first wall 120 or the second wall 122 is lying flat on the attachment surface.

The first inner surface 150 and the second inner surface 152 are disposed orthogonal to one another. As such, an angle 156 between the first inner surface 150 and the third inner surface 154 is at 45° and an angle 158 between the second inner surface 152 and the third inner surface 154 is also at 45°. By orienting the third inner surface 154 at the same angle 156, 158 relative to the first and second walls 120, 122, the housing body 106 is positionable in at least two different orientations and allow insects to access the bait 102. Because the bait 102 is supported on the first and second inner surfaces 150, 152, the bait 102 is axially aligned with the openings 112, 114. In an aspect, the bait 102 is spaced inward and spaced apart from the openings 112, 114. In an aspect, the first inner surface 150 has a surface area that is equal to the second inner surface 152. The third inner surface 154 has a surface area that is greater than the first inner surface 150. The third inner surface 154 also has a surface area that is greater than the second inner surface 152. In examples, the third inner surface 154 has a surface area that is 10% greater than the first or second inner surfaces 150, 152. The third inner surface 154 has a surface area that is 20% greater than the first or second inner surfaces 150, 152. The third inner surface 154 has a surface area that is 30% greater than the first or second inner surfaces 150, 152. The third inner surface 154 has a surface area that is 40% greater than the first or second inner surfaces 150, 152. The third inner surface 154 has a surface area that is 50% greater than the first or second inner surfaces 150, 152.

The first and second openings 112, 114 are disposed opposite of the third inner surface 154 and the third wall 124 so that the openings have a similar position on the housing body 106 no matter what orientation that the housing body 106 has. A cross-sectional area of the interior chamber 104 at the mid-plane is larger than the cross-sectional areas of the interior chamber 104 towards the first and second ends 108, 110. By enlarging the housing body 106 at the middle, more bait 102 can be stored within the housing body 106, while still reducing the size of the openings 112, 114 and allowing access for only insects. In the example, the cross-sectional profile of the interior chamber 104 at the mid-plane is triangular in shape.

The first wall 120 has a first thickness 160, the second wall 122 has a second thickness 162, and the third wall 124 has a third thickness 164. In the example, the thicknesses 160, 162, 164 are equal to each other. In other examples, one or more of the walls 120, 122, 124 may have a different thickness as required or desired.

The first and second end caps 116, 118 are configured to couple to the ends of the housing body 106 to cover and/or seal the first and second openings 112, 114, respectfully. Each end cap 116, 118 includes a projection 166 that corresponds in shape and size to the openings 112, 114, and a flanged cover 168 that at least partially covers the third exterior surface 130. The flanged cover 168 projects outward from the third exterior surface 130 when the end cap is coupled to the housing body 106.

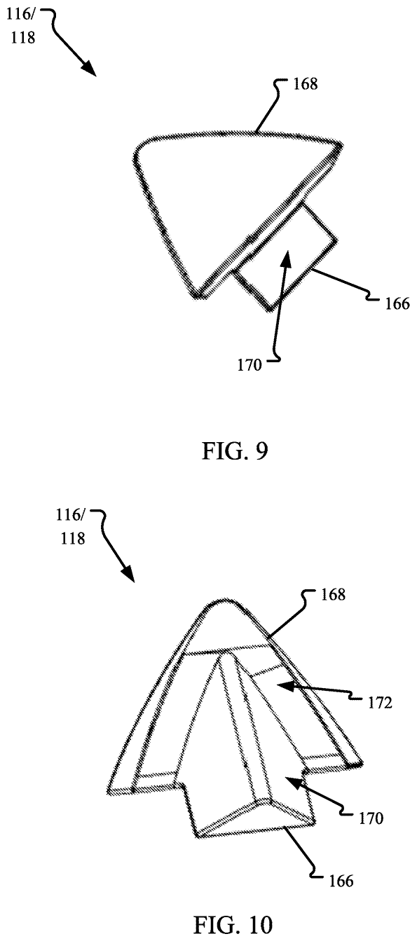

FIGS. 9 and 10 are perspective views of the end caps 116, 118 of the insect bait apparatus 100 (shown in FIG. 1). Referring concurrently to FIGS. 9 and 10, the body of the end caps 116, 118 include the projection 166 and the flanged cover 168. The projection 166 is triangular in shape so as to match the first and second openings 112, 114 of the housing body 106 (shown in FIG. 6). An outer surface 170 of the projection 166 is configured to engage the inner surfaces of the walls of the housing so as to seal the openings 112, 114. The flanged cover 168 extends from the projection 166 and has a larger substantially triangular shape. The flanged cover 168 has an inner surface 172 that is configured to be positioned directly adjacent to the housing body 106. The flanged cover 168 is configured to facilitate removal of the end caps 116, 118 from the housing body 106.

In the example, the body of the end caps 116, 118 may be formed from a material that is the same or similar to that of the housing body 106. In an aspect, the end caps 116, 118 may be formed from a plastic based material. In other examples, the body of the end caps 116, 118 may be formed from a material that is different than that of the housing body 106. In an aspect, the end caps 116, 118 may be formed from an elastomeric material or the like.

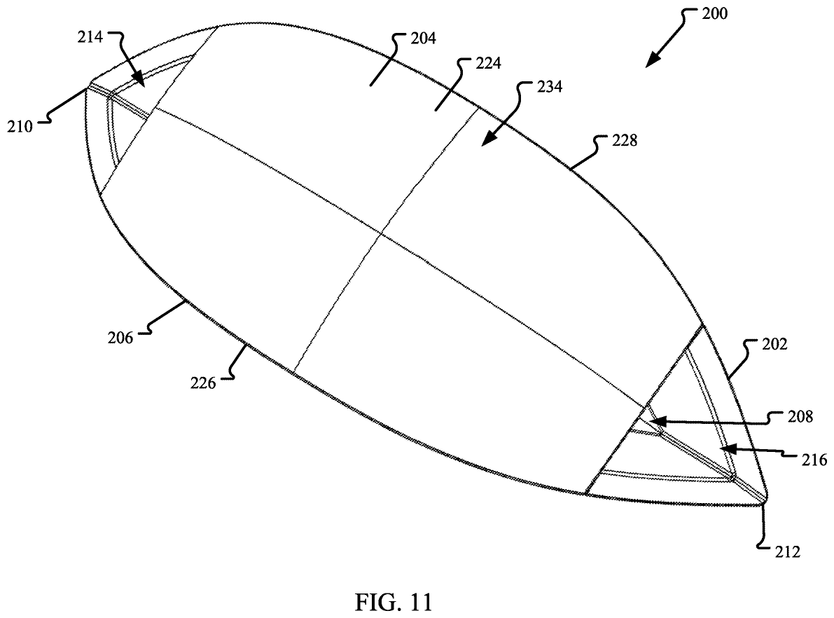

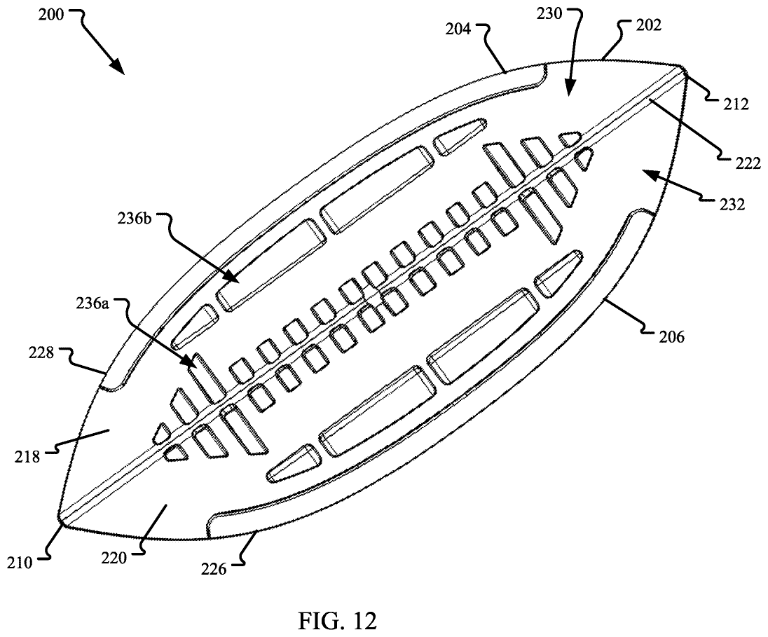

FIG. 11 is a perspective view of another insect bait apparatus 200. FIG. 12 is another perspective view of the insect bait apparatus 200. Referring concurrently to FIGS. 11 and 12, the insect bait apparatus 200 includes a base 202 and a cover 204 that forms a housing body 206 and that defines an interior chamber 208 therein to hold a charge of bait. The housing body 206 includes a first end 210 and an opposite second end 212. The first end 210 defines a first opening 214 that allows access into the interior chamber 208 and the second end 212 defines a second opening 216 that also allows access into the interior chamber 208. In this example, the openings 214, 216 do not have an end cap and are not covered.

The base 202 includes a first wall 218 and a second wall 220 intersecting at a first edge 222 extending between the first end 210 and the second end 212. The cover 204 forms a third wall 224 that defines a second edge 226 proximate the second wall 220 and a third edge 228 proximate the first wall 218. The first wall 218 defines a first outer surface 230, the second wall 220 defines a second outer surface 232, and the third wall 224 defines a third outer surface 234. The openings 214, 216 are formed by the edges of the walls 218, 220, 224 and are positioned adjacent the third outer surface 234. In other examples, the housing body 206 may additionally or alternatively have openings (not shown) that are defined on one or both of the first wall 218 and the second wall 220 in the base 202, and/or on the third wall 224 on the cover 204. These openings provide for other entry/exit locations for insects into the interior chamber 208 as required or desired.

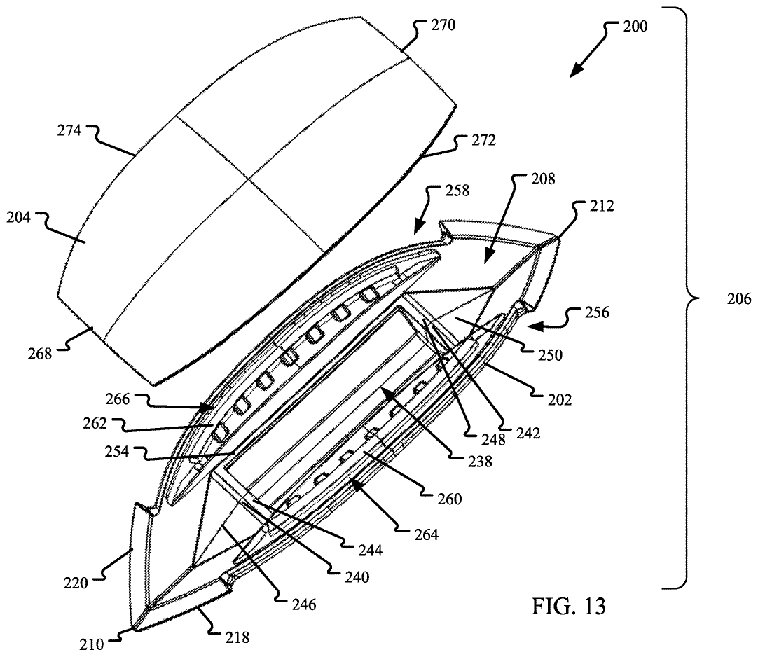

In this example, the first outer surface 230 and the second outer surface 232 include one or more recessed ribs 236 formed therein. In the example, the recessed ribs 236 may be symmetrical about the first edge 222. The recessed ribs 236a may extend substantially orthogonal to the first edge 222 and/or the recessed ribs 236b may extend substantially parallel to the first edge 222. The recessed ribs 236b may be spaced apart from the first edge 222 and adjacent to the third wall 224. The base 202 is an injection molded component and the recessed ribs 236 facilitate the injection molded process and accommodating a bait chamber 238 (shown in FIG. 13) defined inside of the base 202. The cover 204 may also be an injection molded component.

The insect bait apparatus 200 may include at least one adhesive (not shown) for the end user to attached to the first outer surface 230 or the second outer surface 232 as required or desired. In this example, the adhesive is included with the packaging for end user use. As such, even with the recessed ribs 236, the first and second outer surfaces 230, 232 still form a substantially planar surface.

FIG. 13 is an exploded, perspective view of the insect bait apparatus 200. FIG. 14 is another exploded, perspective view of the insect bait apparatus 200. Referring concurrently to FIGS. 13 and 14, the housing body 206 is a two piece component having the base 202 and the cover 204 that are coupled together. The base 202 includes the bait chamber 238 that is formed between the first wall 218 and the second wall 220. The bait chamber 238 is elongated between the first end 210 and the second end 212. A first end 240 of the bait chamber 238 is spaced apart from the first end 210 and an opposite second end 242 of the bait chamber 238 is spaced apart from the second end 212. The bait chamber 238 forms an open cavity to receive the bait within the interior chamber 208 of the housing body 206.

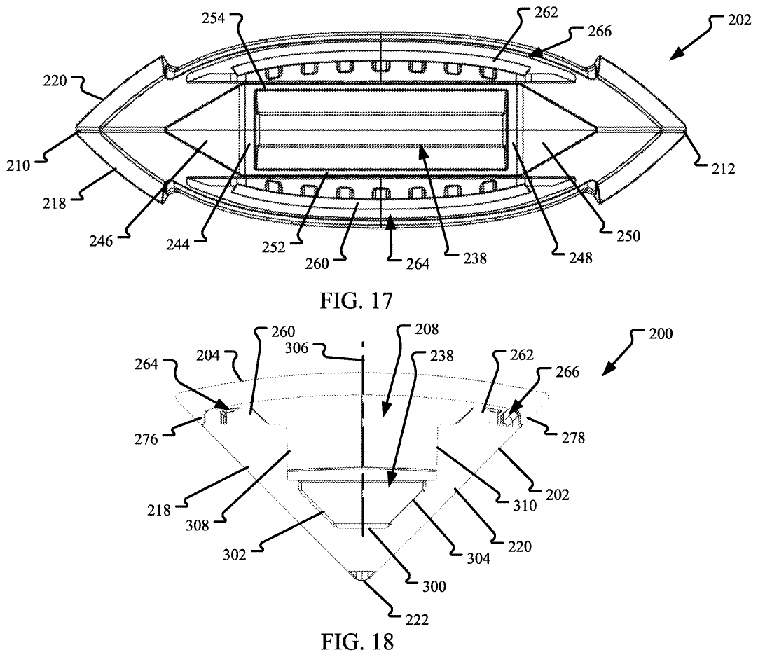

The first end 240 of the bait chamber 238 includes a shoulder 244 that transversely extends between the first wall 218 and the second wall 220 and a ramp 246 that axially extends towards the first end 210 and between the first wall 218 and the second wall 220. The ramp 246 enables insects to climb towards the bait chamber 238 from the first opening 214. The second end 242 of the bait chamber 238 also includes a shoulder 248 and a ramp 250. In the example, the shoulders 244, 248 and the ramps 246, 250 have a similar geometry. In other examples, the shoulders 244, 248 and the ramps 246, 250 may have different geometries. The bait chamber 238 transversely extends between the first wall 218 and the second wall 220 between the two shoulders 244, 248, The transverse sides of the bait chamber 238 also include shoulders 252 (shown in FIGS. 17), 254 at each wall.

Distal ends of both of the first wall 218 and the second wall 220 include a recess 256, 258 configured to receive at least a portion of the cover 204. Disposed between the distal recess 256, 258 and the shoulders 252, 254 on the first and second walls 218, 220, each wall includes a rail 260, 262 forming a channel 264, 266. The rails 260, 262 and the channels 264, 266 extend in a direction from the first end 210 to the second end 212. In the example, the rails 260, 262 and the channels 264, 266 are curved and not linear in shape.

The cover 204 defines a first end 268 and an opposite second end 270 with a first side 272 and a second side 274 extending therebetween. Each side 272, 274 includes a lip 276, 278 extending between the ends 268, 270 that is configured to at least partially wrap around the distal ends of the first wall 218 and the second wall 220, respectively, when the cover 204 is coupled to the base 202. One or more tabs 280 are disposed adjacent from the lips 276, 278 and spaced apart therefrom. In the example, there are a plurality of discrete tabs 280 that are spaced apart from one another. The tabs 280 are configured to be received at least partially within the channels 264, 266 defined in the base 202. In the example, the distal ends of the tabs 280 includes a nose projection. To couple the cover 204 to the base 202, the tabs 280 may be ultrasonically welded within the channels 264, 266 with the nose projections providing weldable material. The cover 204 may couple to the base 206 by any other connection means as required or desired (e.g., press-fit, snap-fit, etc.). The tabs 280 extend from an inner surface 282 of the cover 204.

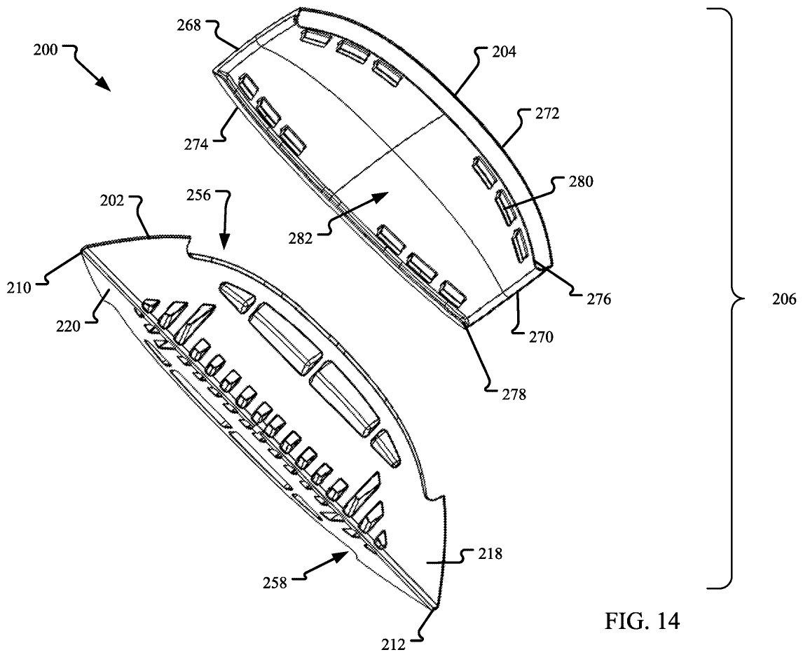

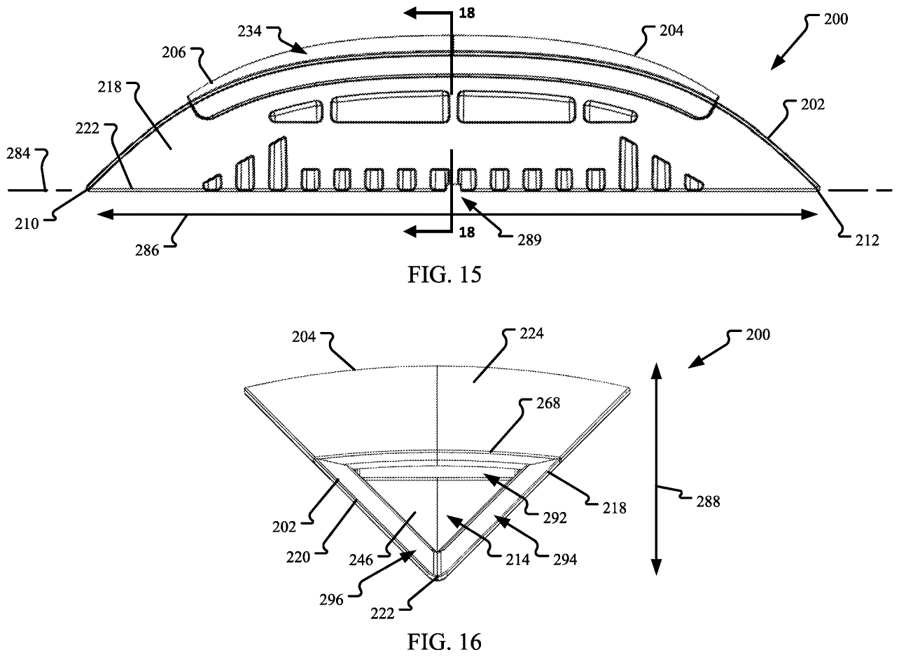

FIG. 15 is a side view of the first wall 218 of the insect bait apparatus 200. FIG. 16 is an end view of the insect bait apparatus 200. Referring concurrently to FIG. 15, and 16, the first end 210 and the second end 212 defines a longitudinal axis 284. The first wall 218 is formed by the base 202 and a portion of the cover 204. The housing body 206 is axially symmetrical and has an axial length 286 larger than a midpoint height 288. In an aspect, the height 288 is less than half of the length 286. In another aspect, the height 288 is less than a quarter of the length 286. The first edge 222 may include a notch 289 at a midpoint. In the example, the cover 204 has the outer surface 234 that projects from an outer perimeter of the base 202 when viewed from the side. The side view from the second wall 220 is similar.

The first end 268 of the cover 204 at least partially defines the first opening 214. In the example, the first end 268 is disposed vertically above the first ramp 246. As such, an axial gap 292 is formed when viewed from the end with the bait chamber 238 smaller than the first opening 214. The second opening 216 (shown in FIG. 11) has a similar geometry. The ends of the first and second walls 218, 220 at the openings 214, 216 define an oblique surface 294, 296 that is orientated at an angle less than 90° so that insects can more easily enter into the insect bait apparatus 200. In the example, the openings 214, 216 are formed by the first, second, and third walls 218, 220, 224. The third wall 224 may be curved in both the longitudinal direction and a transverse direction such that an outer profile of the housing body is substantially triangle shaped with a curved top edge.

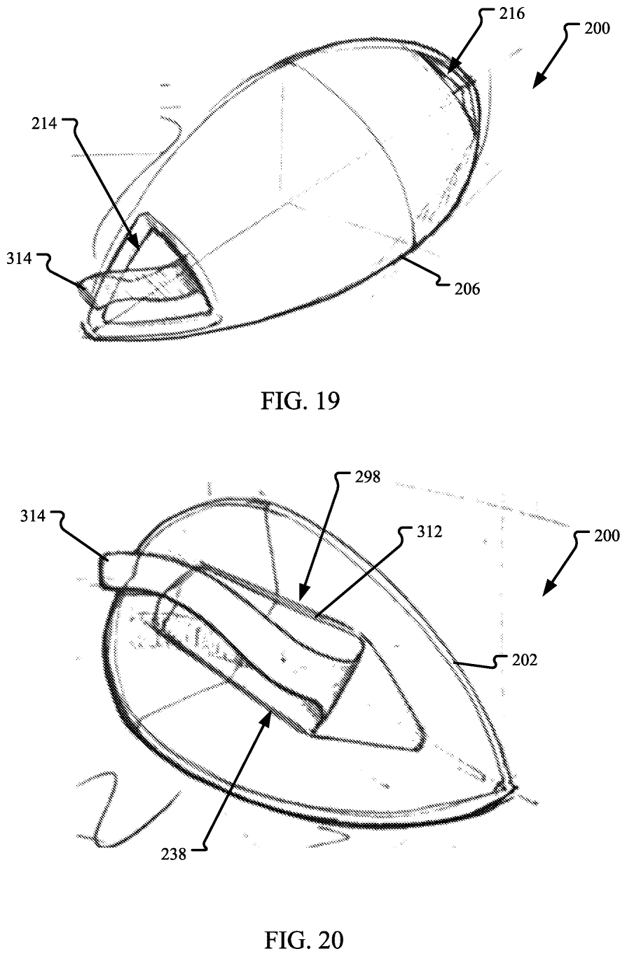

FIG. 17 is a plan view of the base 202 of the insect bait apparatus 200 (shown in FIG. 11). FIG. 18 is a cross-sectional view of the insect bait apparatus 200 taken along line 18-18 as shown in FIG. 15. Referring concurrently to FIGS. 17 and 18, certain features are described above and are not necessarily described further. The bait chamber 238 extends along the longitudinal axis 284 (shown in FIG. 15) and is bounded by the shoulders 244, 248, 252, 254. When the cover 204 is not attached to the base 202, the bait chamber 238 is completely open to facilitate assembly and bait being placed therein. In one example, the bait within the bait chamber 238 may not be sealed within the insect bait apparatus 200. Rather, the packaging for the insect bait apparatus 200 may provide the sealing. In other examples, the shoulders may be used to for a tear-away seal 298 (shown in FIGS. 19-20) to be used and for sealing the bait. A pull-tab can extend through the openings to tear-away the seal 298 prior to use.

The bait chamber 238 may include a bottom surface 300 and two oblique surfaces 302, 304 such that the chamber is substantially trapezoidal in shape when viewed from a cross-section. The oblique surfaces 302, 304 may be angled similar to the first and second walls 218, 220, respectively, and facilitate bait being received within the base 202. A centerline axis 306 of the bait chamber 238 may bisect the first edge 222 such that the bait chamber 238 has the same geometry if the first wall 218 or the second wall 220 is placed on the underlying surface. In the example, the bait chamber 238 has a trapezoidal shape in cross-section.

Once the bait is within the bait chamber 238, the cover 204 is placed over the base 202 and ultrasonically welded. The lips 276, 278 of the cover 204 at least partially wrap around the distal ends of the first and second walls 218, 220. Also, the tabs 280 (shown in FIG. 14) of the cover 204 are received in the channels 264, 266 adjacent the rails 260, 262 for the welding. The cover 204 is spaced apart from the bait chamber 238 with sidewalls 308, 310 at least partially extending therebetween. This provides space for the insects to enter and exit the interior chamber 208 and climb over the ramps 246, 250 and sidewalls 308, 310 as required or desired. The bait chamber 238 is symmetrical relative to the mid-point so that the insect bait apparatus 200 can be used in more than one orientation.

FIG. 19 is a schematic view of the seal 298 for the insect bait apparatus 200. FIG. 20 is another schematic view of the seal 298 for the insect bait apparatus 200. Referring concurrently to FIGS. 19-20 the seal 298 includes a sealing cover 312 that is configured to seal the bait within the bait chamber 238 (e.g., via engagement with the shoulders) and a pull-tab 314 coupled to the sealing cover 312. The pull-tab 314 is elongated so that a free end extends out of one or both of the openings 214, 216. By using the seal 298, the end user can unseal the bait when required or desired and without needing to open the housing body 206 activating the insect bait apparatus 200 as required or desired. The sealing cover 312 may be a foil and/or a film.

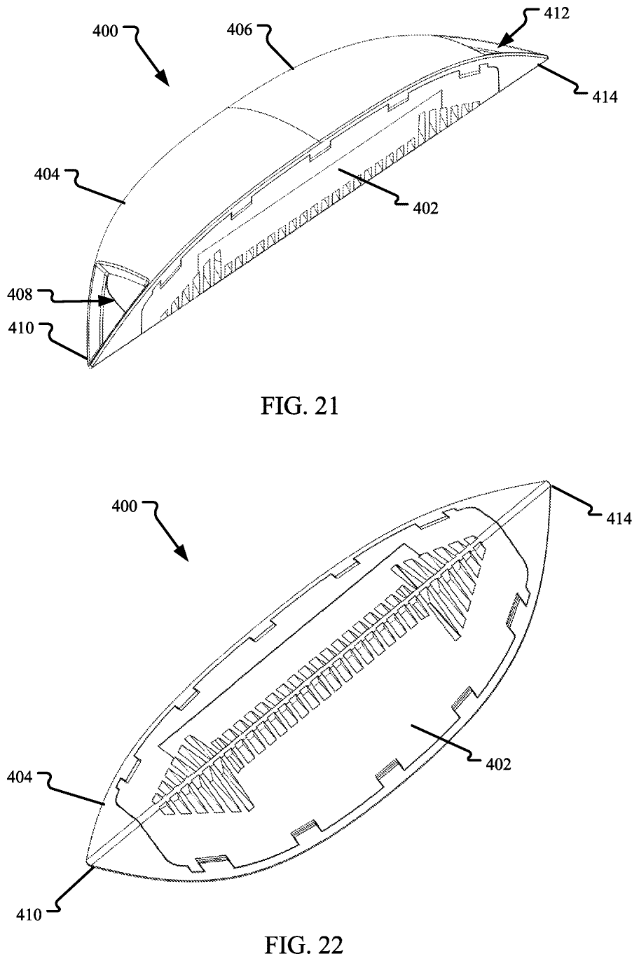

FIG. 21 is a perspective view of another insect bait apparatus 400. FIG. 22 is another perspective view of the insect bait apparatus 400. Referring concurrently to FIGS. 21 and 22, the insect bait apparatus 400 includes a base 402 and a cover 404 forming the housing body 406. However, in this example, the cover 404 completely defines a first opening 408 at a first end 410 and a second opening 412 at a second end 414. As such, the cover 404 is axially longer than the base 402 (as described above the cover 204 is axially shorter than the base 202). Other features, such as the bait chamber, recessed rib, etc., are described above and are not necessarily described further.

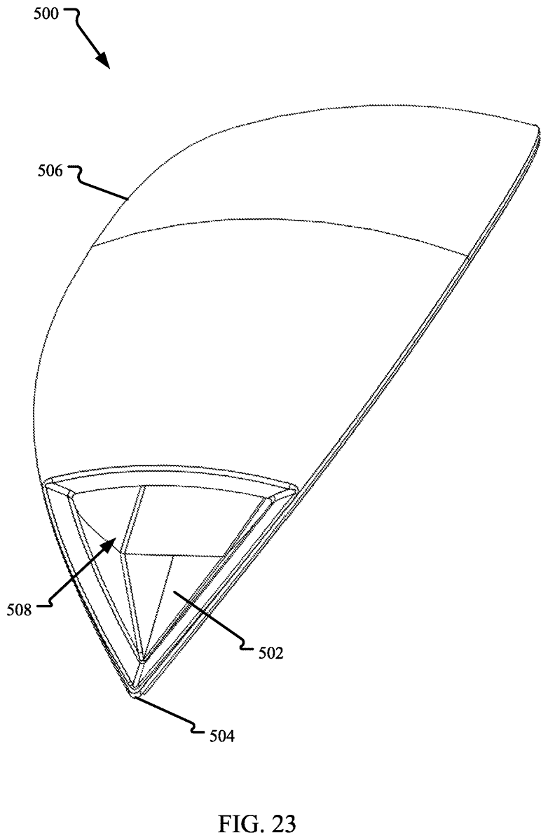

FIG. 23 is a perspective view of another insect bait apparatus 500. In this example, a ramp 502 of the bait chamber extends to an end 504 of a housing body 506 and is at an opening 508. In this example, by positioning the ramp 502 closer to the ends 504, the bait chamber can be elongated further. Other features, such as the housing body, etc., are described above and are not necessarily described further.

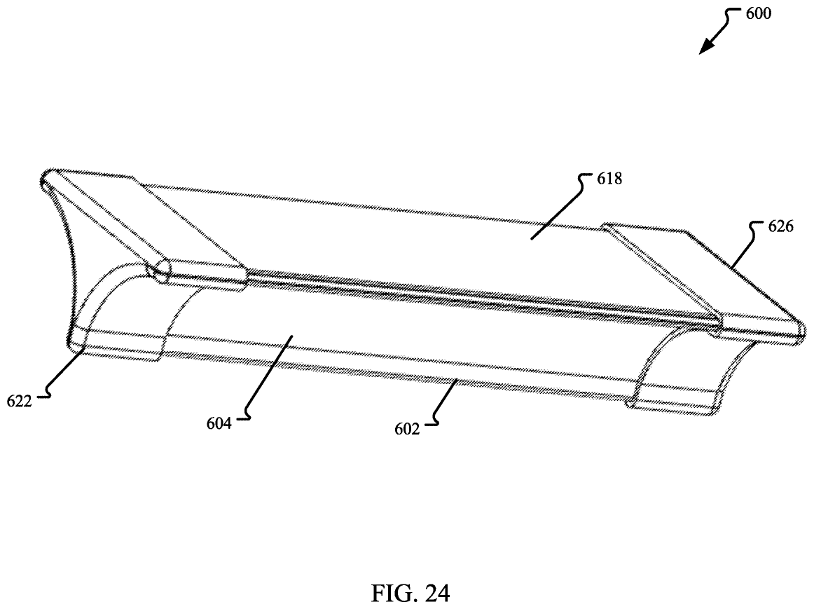

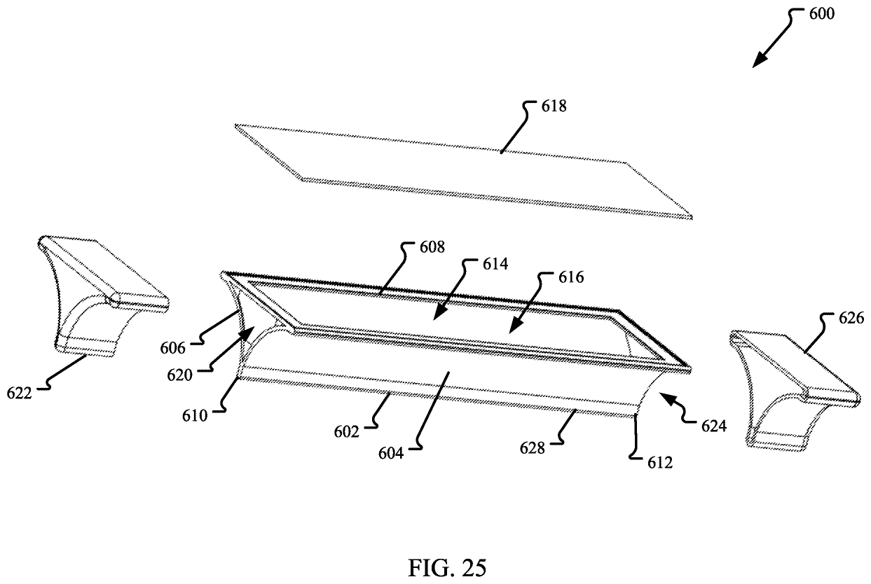

FIG. 24 is a perspective view of another insect bait apparatus 600. FIG. 25 is an exploded, perspective view of the insect bait apparatus 600. Referring concurrently to FIGS. 24 and 25, the insect bait apparatus 600 includes a housing body 602 having a first wall 604, a second wall 606, and a third wall 608 in a triangular shape and extending between a first end 610 and a second end 612. The housing body 602 defines an interior chamber 614 configured to hold bait therein. In this example, the third wall 608 defines an elongated opening 616 and the insect bait apparatus 600 includes an adhesive 618 that couples to the housing body 602 and covers the opening 616. The first end 610 defines a first opening 620 that is configured to removably receive a first end cap 622. The second end 612 defines a second opening 624 that is configured to removably receive a second end cap 626.

In this example, the third wall 608 is a planar wall, while the first and second walls 604, 606 are curved. An edge 628 between the first and second walls 604 forms a wedge so that the insect bait apparatus 600 can be wedged into cracks and crevices in a first orientation. In another orientation, the adhesive 618 can be used to secure to housing body 602 to an attachment surface. The bait is supported within the interior chamber 614 and at the intersection of the first wall 604 and the second wall 606 so that the bait is accessible by insects in any orientation of the insect bait apparatus 600. In other examples, the bait can be supported along the third wall 608. In this example, the openings 620, 624 are orthogonal along the longitudinal axis of the housing body 602.

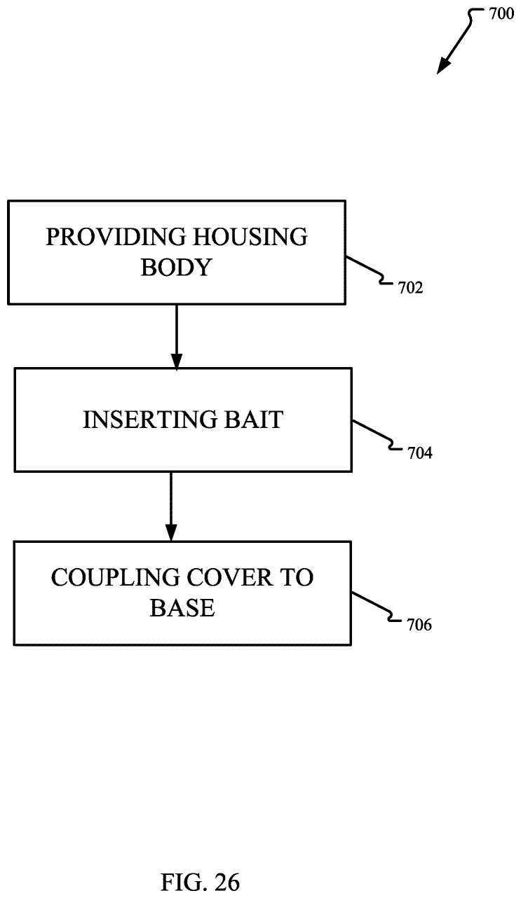

FIG. 26 illustrates a flowchart depicting a method 700 of assembling an insect bait apparatus. The example methods and operations can be implemented or performed by the assemblies described herein (e.g., the insect bait apparatuses 100, 200, 400, 500, and 600 shown in FIGS. 1-25). The method 700 begins with providing a housing body (operation 702). In examples, the housing body includes a base having a first wall and a second wall, the first wall and the second wall extend orthogonally from each other from an edge. A bait chamber extends between the first wall and the second wall and has a centerline axis that bisects the edge. A cover forms a third wall, and the base and the cover at least partially define an interior chamber with the bait chamber captured therein. The housing body extends between a first end and a second end defining a longitudinal axis. The first end defining a first opening into the interior chamber and the second end defining a second opening into the interior chamber.

Bait having at least one active ingredient is inserted within the bait chamber (operation 704). The bait may have a liquid form that is first injected into the bait chamber (e.g., with cover removed) that then solidifies. In examples, the bait can be sealed within the housing body with the packaging for the insect bait apparatus. In other examples, the bait can be sealed with a pull-tab seal covering the bait chamber. The cover is coupled to the base forming the housing body with the bait disposed therein (operation 706). In an example, the cover is ultrasonically welded to the base.

The insect bait apparatuses described herein facilitates versatile placement options so that baiting insect infestation areas are more easily enabled. The insect bait apparatus has a longitudinally elongated housing body with three walls. A bait chamber facilitates supporting the bait within the housing body, and two walls may be used to place the insect bait apparatus in at least two different placement orientations, the bait chamber being useable in each placement orientation. Each end of the housing body includes an opening allowing insect access to the bait.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative figures. Additionally, the inclusion of a structural or method feature in a particular figure is not meant to imply that such feature is required in all examples and, in some examples, may not be included or may be combined with other features.

References in the specification to “one example,” “an example,” “an illustrative example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). Moreover, one having skill in the art will understand the degree to which terms such as “about,” “approximately,” or “substantially” convey in light of the measurement techniques utilized herein. To the extent such terms may not be clearly defined or understood by one having skill in the art, the term “about” shall mean plus or minus ten percent.

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

1. An insect bait apparatus configured to hold bait having at least one active ingredient, the apparatus comprising:
a housing body including:
a first end and an opposite second end defining a longitudinal axis;
a first wall and a second wall extending from an edge, wherein the first wall has a first exterior surface and the second wall has a second exterior surface, the first exterior surface at a 90° angle relative to the second exterior surface;
a third wall extending between the first wall and the second wall, the first wall, the second wall, and the third wall defining an interior chamber of the housing body;
a bait chamber extending between the first wall and the second wall within the interior chamber, the bait chamber configured to at least partially receive the bait;
a first opening defined at the first end allowing access to the interior chamber; and
a second opening defined at the second end allowing access to the interior chamber.

2. The insect bait apparatus of claim 1, wherein the housing body has a cross-sectional profile that is larger at a mid-plane than at the first end or the second end.

3. The insect bait apparatus of claim 2, wherein the housing body is symmetrical about the mid-plane.

4. The insect bait apparatus of claim 1, wherein the edge is a first edge, the housing body also including a second edge at an intersection of the first wall and the third wall, wherein the first edge is linear between the first and second ends and the second edge is curved between the first and second ends.

5. The insect bait apparatus of claim 1, wherein the first exterior surface has a surface area that is equal to the second exterior surface.

6. The insect bait apparatus of claim 1, wherein the third wall has a third exterior surface, the third exterior surface having a surface area that is greater than the first exterior surface.

7. The insect bait apparatus of claim 1, wherein the first opening is axially aligned with the second opening along the longitudinal axis.

8. The insect bait apparatus of claim 1, wherein the first opening and the second opening are completely defined by the first wall, the second wall, and the third wall.

9. The insect bait apparatus of claim 1, wherein the bait chamber includes a first ramp adjacent the first opening and a second ramp adjacent the second opening.

10. The insect bait apparatus of claim 1, wherein the housing body is rigid.

11. The insect bait apparatus of claim 1, wherein the first wall and the second wall are integrally formed as a base and the third wall is a cover, the cover ultrasonically welded to the base to form the housing body.

12. The insect bait apparatus of claim 1, wherein the interior chamber is free from any moving components.

13. The insect bait apparatus of claim 1, further comprising an adhesive disposed at least partially on the first exterior surface, the second exterior surface, or both the first and second exterior surfaces.

14. The insect bait apparatus of claim 1, wherein the bait chamber includes at least one shoulder, and wherein a pull-tab seal engages with the at least one shoulder to seal the bait therein.

15. An insect bait apparatus comprising:
a housing body including:
a base having a first wall and a second wall, wherein the first wall and the second wall extend orthogonally from each other from an edge, a bait chamber extends between the first wall and the second wall and has a centerline axis that bisects the edge; and
a cover forming a third wall, wherein the base and the cover at least partially define an interior chamber with the bait chamber captured therein, wherein the housing body extends between a first end and a second end defining a longitudinal axis, the first end defining a first opening into the interior chamber and the second end defining a second opening into the interior chamber; and bait having at least one active ingredient disposed within the bait chamber.

16. The insect bait apparatus of claim 15, wherein the third wall is non-planar and the first wall and the second wall are substantially planar.

17. The insect bait apparatus of claim 15, wherein the bait chamber is elongated along the longitudinal axis with a first ramp proximate the first opening and a second ramp proximate the second opening.

18. The insect bait apparatus of claim 15, wherein the bait chamber has a trapezoidal cross-sectional shape.

19. The insect bait apparatus of claim 15, wherein distal ends of the first and the second wall define a channel and the third wall includes one or more tabs, the one or more tabs receivable within the channel to couple the cover to the base.

20. The insect bait apparatus of claim 19, wherein the cover is ultrasonically welded to the base.

21. The insect bait apparatus of claim 15, further comprising a seal for the bait chamber.

22. The insect bait apparatus of claim 21, wherein the seal has a pull-tab extending from the first opening or the second opening.

23. The insect bait apparatus of claim 15, wherein the housing body is symmetrically about the edge.

24. The insect bait apparatus of claim 15, further comprising an adhesive configured to be applied at least partially on an outer surface of the housing body.

25. A method of assembling an insect bait apparatus comprising:
providing a housing body including a base having a first wall and a second wall, the first wall and the second wall extend orthogonally from each other from an edge, a bait chamber extends between the first wall and the second wall and has a centerline axis that bisects the edge, and a cover forming a third wall, the base and the cover at least partially define an interior chamber with the bait chamber captured therein, the housing body extends between a first end and a second end defining a longitudinal axis, the first end defining a first opening into the interior chamber and the second end defining a second opening into the interior chamber;
inserting bait having at least one active ingredient within the bait chamber; and
coupling the cover to the base forming the housing body with the bait disposed therein.

26. The method of claim 25, further comprising providing an adhesive configured to be applied at least partially on an outer surface of the housing body.

27. The method of claim 25, further comprising sealing the housing body in packaging.

28. The method of claim 25, further comprising sealing the bait chamber with a pull-tab seal.
